(19) United States
(12) Patent Application Publication
(10) Pub. No.: US 2011/0304105 A1
(43) Pub. Date: Dec. 15, 2011

(54) DIFFUSION AND SORPTION FREE GASKETS FOR GAS EXCHANGE MEASUREMENT SYSTEMS

(75) Inventors: Mark A. Johnson, Hickman, NE (US); Andrew Steven Parr, Lincoln, NE (US)

(73) Assignee: LI-COR, Inc., Lincoln, NE (US)

(21) Appl. No.: 12/815,214

(22) Filed: Jun. 14, 2010

(51) Int. Cl. F16J 15/10

(52) U.S. Cl. 277/645

(57) ABSTRACT

Gaskets are provided for use in gas exchange measurement systems used for photosynthesis, respiration and transpiration measurements. Novel gaskets and gasket designs are provided, including composite gasket designs, along with corresponding construction techniques, which effectively provide low diffusion through bulk material, significant reductions in interfacial diffusion, sufficient compliance to conform to surface irregularities under low applied stresses, and/or low sorption properties, particularly of H₂O vapor.

### BACKGROUND

The present invention relates generally to gas exchange measurement systems, and more particularly to gasket designs for use in gas exchange systems used in photosynthesis, respiration and transpiration measurements.

The ability to regulate CO₂ and H₂O concentrations in and around the leaf are critical to accurate photosynthesis, respiration and transpiration measurements, and are a key function of the leaf chamber. The ideal chamber must not impact the dynamic control or measurement of CO₂ and H₂O concentrations. A well known artifact of leaf chamber construction is the uncontrolled release or retention of CO₂ or H₂O by leaf chamber surfaces. This phenomenon is generally known as sorption, and describes both adsorption and desorption. Adsorption is the retention of CO₂ or H₂O molecules on the chamber surfaces. Desorption is the release of CO₂ or H₂O molecules from the chamber surfaces. Chamber materials are carefully chosen to minimize sorption. Often, leaf chambers made from materials with objectionable sorption properties can be coated with secondary materials which minimize sorption.

Diffusion in gas-exchange systems, and particularly in photosynthesis systems, results in parasitic gains and losses of gas species (e.g., CO₂ and H₂O vapor). It is often impossible to differentiate these parasitic gains and losses from those which are being measured (e.g., from leaf photosynthesis or transpiration). Thus, any diffusion into or out of a gas exchange system results directly in a measurement error. The diffusion problem is well known and studied in the photosynthesis community.

The effect of diffusion is particularly pronounced in the following situations:

1. when gas concentrations (e.g., CO₂ or H₂O) inside the system are greatly different than those outside the system

2. when flow rates through an open system are small, such that a low diffusion rate into a small flow can result in a large concentration change

3. when measured gas exchange rates (e.g., photosynthesis and/or transpiration rates) are small, and parasitic sources/sinks are comparable to the rates being measured

Gaskets, O-rings, and compression fittings can be used to seal between the mechanical components of a gas exchange system. These traditional sealing methods are often sufficient to prevent both leaks (species-independent flow due to pressure gradients) and diffusion (species-specific flow due to concentration gradients). In many mechanical joints, large stresses can be applied to both the joint and the sealing element, creating a leak and diffusion free joint.

Gas exchange systems often have joints which impose limits on the stresses that can be applied. For example:

1. Photosynthesis systems require a leak-free seal between the sample chamber and a relatively fragile leaf. Large stresses could damage or puncture the leaf. Leaf seals require the use of soft gaskets so sufficient deformation can be obtained to seal under these low stresses.
2. For large-volume soil respiration chambers (e.g. LI-COR 8100-101, 8100-103, 8100-104 instruments) in which relatively large surface areas must be sealed, the large surface area limits the amount of stress that can be applied to gaskets, as the stress must be uniformly distributed over a large area.
3. For gas exchange components (e.g., valves, flow-meters, fittings, manifolds) made from non-metallic materials (e.g. plastics) which cannot tolerate the large stresses used in traditional gasketed joints.
Several gasket materials are available which are sufficiently compliant to seal pressure leaks in the above applications, but the elimination of diffusive leaks in these situations remains largely unsolved.

A gas-exchange gasket must also possess low sorption characteristics, particularly for H₂O vapor. As discussed above, sorption refers to the ability of a material to retain (adsorption) or release (desorption) molecules from the material surface. For example, in a transient plant transpiration measurement, the sorption of H₂O vapor cannot be differentiated from transpiration. More often, the sorption of H₂O vapor increases the time required for a gas exchange system to reach equilibrium.

Therefore it is desirable to provide systems and methods that overcome the above and other problems.

### BRIEF SUMMARY

The present invention provides gaskets for use in gas exchange systems, and more particularly, gaskets for use in gas exchange systems used for photosynthesis, respiration and transpiration measurements.

According to various embodiments, gaskets are provided for use in gas exchange systems, which meet one or more of the following requirements: 1) low diffusion through bulk material, 2) sufficient compliance to conform to surface irregularities under low applied stresses, 3) minimal diffusion through the gasket interface surfaces (low interfacial diffusion) and 4) low sorption properties, particularly for H₂O vapor. Although there exist gaskets which solve some of these problems, the recognition of interfacial diffusion as a primary contributor, and material choices which target interfacial diffusion, are novel.

In certain embodiments, novel gaskets and gasket designs are provided, including composite gasket designs, along with corresponding construction techniques, which effectively meet all the above requirements. Certain aspects of the invention rely on the following: a) gasket diffusion in low applied stress applications is shown to be dominated by interfacial diffusion rather than diffusion through the bulk material; for cases of practical interest, if this interfacial diffusion is effectively eliminated, diffusion through the bulk material is negligible, and b) unique construction techniques are presented which allow two materials with unique properties to be combined together in a single cost-effective composite gasket. More specifically, certain aspects use a material which meets requirements 1, 2 and 3 above, and integrates a second material which allows the composite gasket to meet all four of the requirements.

According to one aspect of the present invention, a gasket for use in a gas exchange system is provided. The gasket typically includes a structure comprising a first material and having an interior surface defining an interior region, and an exterior surface. When the structure is positioned between two surfaces in a gas exchange analysis chamber, the interior region defines an internal volume between the two surfaces, and the first material reduces or eliminates interfacial diffusion of gases between the internal volume and the atmosphere external to the gasket during a gas exchange experiment. In certain aspects, the first material reduces or eliminates interfacial diffusion of gases such as CO₂, CO₂ isotopes, O₂, H₂O, Methane (CH₄), N₂O, Isoprene and others. In certain aspects, the first material comprises a solid or foamed elastomer such as a solid or foamed urethane. Examples of solid urethanes are FastFlex® and Sorbothane®. In certain aspects, at least the interior surface of the structure is coated with a hydrophobic material coating, wherein the hydrophobic coating creates a sorption barrier that reduces or eliminates sorption of H₂O between the internal volume and the gasket structure. Useful hydrophobic coating materials include fluoropolymers (e.g. PTFE) and Parylene®. Fluoropolymer is a general class of “plastics” which includes many materials such as PTFE, PCTFE, ETFE, etc). In certain aspects, a hydrophobic material is affixed to at least the interior surface of the structure, wherein the hydrophobic material creates a sorption barrier that reduces or eliminates sorption of H₂O between the internal volume and the gasket structure. In certain aspects, the hydrophobic material includes a solid or foamed elastomer. Useful solid or foamed elastomers include polyethylene, Neoprene®, EPDM, SBR, Buna-N and vinyl.

According to another aspect of the present invention, a composite gasket for use in a gas exchange system is provided. The gasket typically includes a first gasket portion having an interior surface defining an interior region, and an exterior surface, the first gasket portion comprising a first material, and a second gasket portion affixed to the exterior surface of the first gasket portion, the second gasket portion comprising a second material. When the composite gasket is positioned between two surfaces, the interior region defines an internal volume between the two surfaces, and the first material creates a sorption barrier that reduces or eliminates sorption of H2O between the internal volume and the composite gasket, and the second material reduces or eliminates interfacial diffusion of gases between the internal volume and the atmosphere external to the gasket. In certain aspects, the second material reduces or eliminates interfacial diffusion of gases such as CO₂, CO₂ isotopes, O₂, H₂O, Methane (CH₄), N₂O, Isoprene and others. In certain aspects, the first material is hydrophobic. In certain aspects, the hydrophobic material includes a solid or foamed elastomer. Useful solid or foamed elastomers include polyethylene, Neoprene®, EPDM, SBR, Buna-N and vinyl. In certain aspects, the first material includes a layer of a fluoropolymer (e.g. PTFE) or Parylene®. In certain aspects, the second material includes a solid or foamed elastomer such as a solid or foamed urethane. Examples of useful urethanes are FastFlex® and Sorbothane®.

According to yet another aspect of the present invention, a gasket for use in a gas exchange system is provided. The gasket typically includes a base material defining a structure having an interior surface defining an interior region, and an exterior surface, and a second material affixed to or coating at least the interior surface of the gasket structure. When the gasket is positioned between two surfaces, the interior region defines an internal volume between the two surfaces, the second material creates a sorption barrier that reduces or eliminates sorption of H2O between the internal volume and the gasket, and the base material reduces or eliminates interfacial diffusion of gases between the internal volume and the atmosphere external to the gasket. In certain aspects, the base material reduces or eliminates interfacial diffusion of gases such as CO₂, CO₂ isotopes, O₂, H₂O, Methane (CH₄), N₂O, Isoprene and others. In certain aspects, the base material includes a solid or foamed elastomer such as a solid or foamed urethane. Examples of useful urethanes are Sorbothane® and FastFlex® In certain aspects, the second material is hydrophobic. In certain aspects, the hydrophobic material includes a solid or foamed elastomer. Useful solid or foamed elastomers include polyethylene, Neoprene®, EPDM, SBR, Buna-N and vinyl. In certain aspects, the second material includes a layer of fluoropolymer (e.g. PTFE) or Parylene®.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an inner test chamber with a leaf gasket.

FIG. 2 illustrates a spring loaded sealing plate placed over the leaf gasket to seal the inner test chamber.

FIG. 3 illustrates an outer test chamber with an O-ring seal.

FIG. 4 shows the assembly in FIG. 2 lowered into the outer test chamber of FIG. 3.

FIG. 5 shows the entire test chamber assembly plumbed to a LI-COR LI-7000 gas analyzer.

FIG. 6 illustrates changes of gasket CO₂ diffusion.

FIG. 7 illustrates a gasket structure according to one embodiment.

### DETAILED DESCRIPTION

The present invention provides gaskets for use in gas exchange systems and more particularly gaskets for use in gas exchange systems used for photosynthesis, respiration and transpiration measurements.

According to various embodiments, gaskets are provided for use in gas exchange systems, which provide low diffusion through bulk material, sufficient compliance to conform to surface irregularities under low applied stresses, minimal interfacial diffusion, and/or low sorption properties, particularly of H₂O vapor. For example, various embodiments effectively reduce or eliminate diffusion of gases such as CO₂ and its isotopologues, H2O and its isotopologues, CH₄ and its isotopologues, O₂, N₂, N₂O, VOCs including but not limited to isoprene, and other gases.

The following experiments demonstrate that in traditional photosynthesis system leaf chamber gaskets, the primary diffusion occurs at gasket interfaces, not through the bulk gasket material. This is a fundamental paradigm shift regarding diffusion in leaf chamber gaskets. Past approaches have attempted to identify the perfect gasket material, with “perfect” defined as no bulk diffusion. The experiments, however, indicate that bulk material diffusion is often a minor contributor compared to interfacial diffusion. Because of low contact stresses, leaf gasket diffusion is dominated by interfacial diffusion between the gasket material and the mating surface.

The experiments introduce an artificially extreme CO₂ concentration gradient across a series of gasket materials. A large (50,000 PPM) CO₂ concentration is established in a volume on one side of the gasket (outer side). A constant mass flow (0.5 SLPM) is used to ensure that the concentration gradient does not diminish as diffusion occurs. A stream of CO₂ free air (0 PPM CO₂) is passed through the volume on the opposing side (inner side) of the gasket at a mass flow rate (0.5 SLPM). With an ideal leak-free and diffusion-free gasket, the air stream exiting the inner volume will remain CO₂ free. Real gaskets diffuse CO₂, and therefore the stream exiting the inner volume would have a measurable increase in CO₂ concentration.

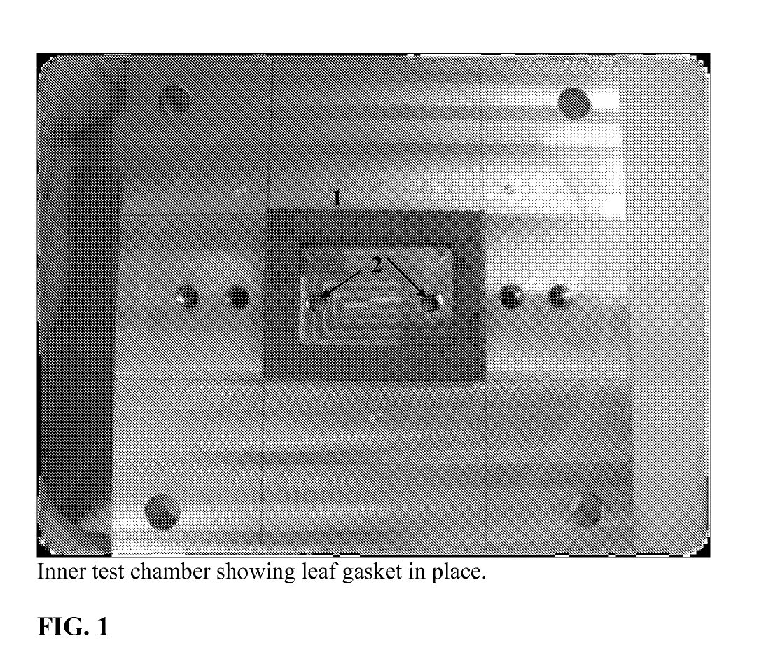

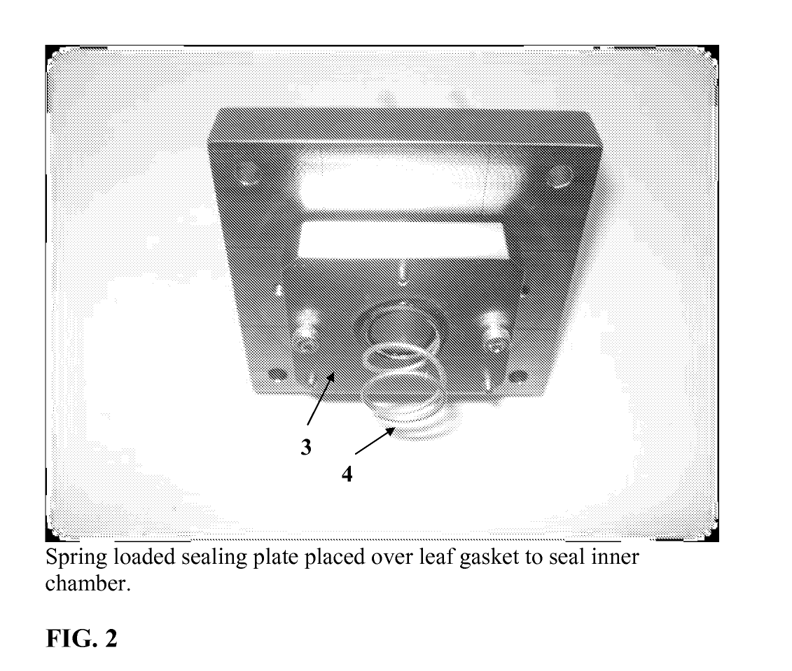

For simplicity, only relative comparisons are made between different gasket configurations under the same CO₂ gradients and flow rates. These relative comparisons are sufficient to demonstrate the significance of interfacial diffusion. FIG. 1 shows a typical foamed Neoprene® gasket 1 with a 2 cm by 3 cm aperture. The volume on the interior of the gasket 1 in FIG. 1 is the inner volume. There are two ports 2 into the inner volume which are the entrance and exit of the 0 PPM CO₂ stream. This inner volume of FIG. 1 is sealed with a solid metal plate 3 as shown in FIG. 2. The solid metal plate 3 has a compression spring 4 adhered to the bottom. When the assembly is complete, the compression spring 4 applies a constant compressive stress to the leaf gasket. Because all gaskets had the same dimensions, the interfacial stresses for all gaskets are nearly identical. There will be slight variations in interfacial stresses due to minor differences in gasket thickness and stiffness.

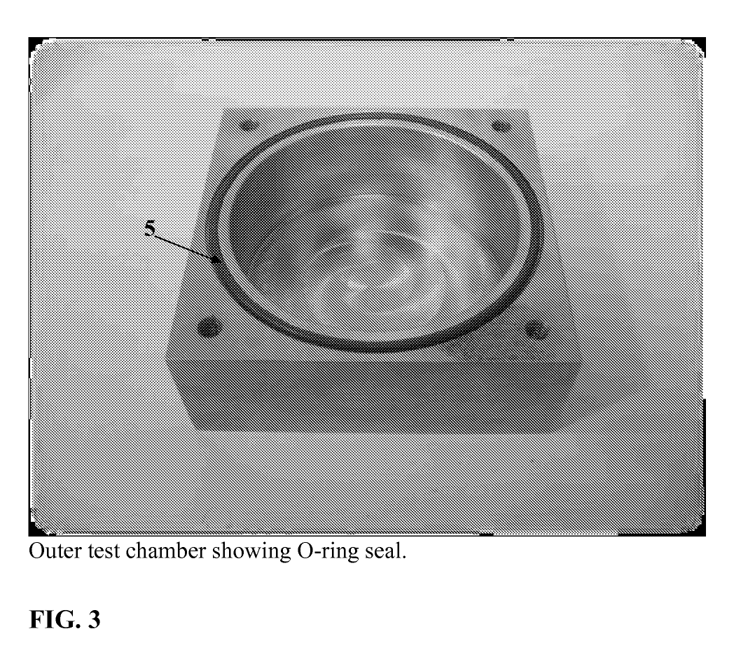

The assembly of FIG. 2 is then lowered into the outer test chamber shown in FIG. 3. The O-ring seal 5 of FIG. 3 creates a tight seal with the larger rectangular plate of FIG. 2. The interior cylindrical volume in FIG. 3 is the outer chamber, and it is purged with 50,000 PPM CO₂ at a mass flow rate of 0.5 SLPM.

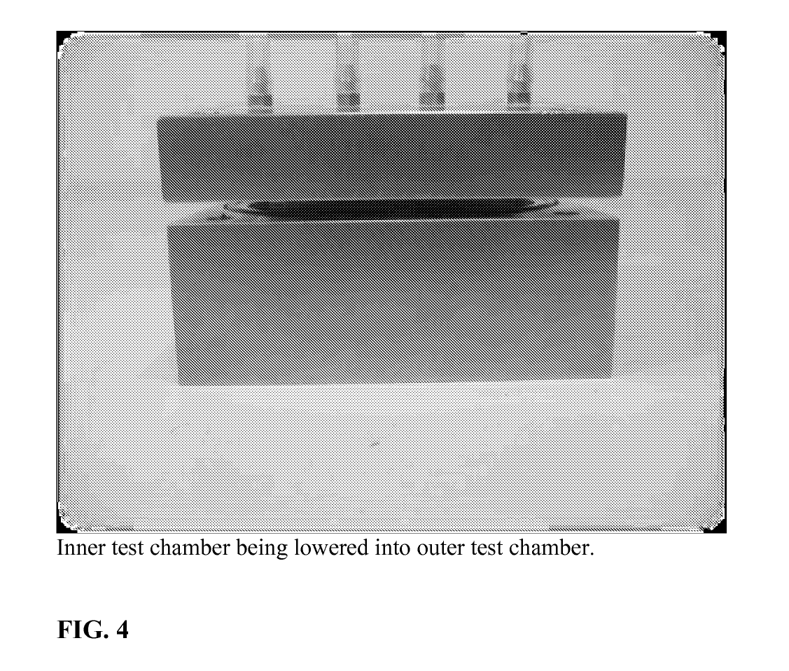

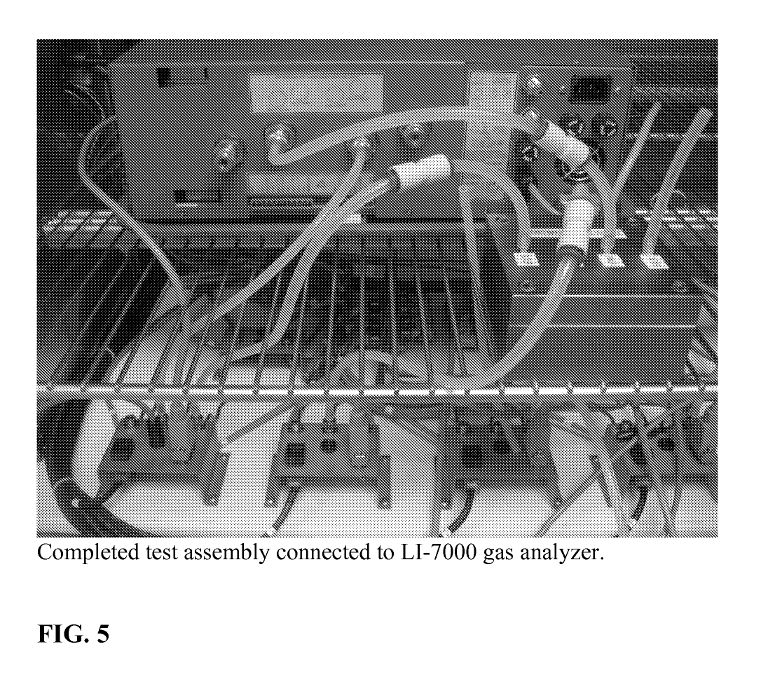

FIG. 4 shows the assembly in FIG. 2 lowered into the outer chamber of FIG. 3. As this assembly is lowered, the spring compresses and applies a repeatable compressive stress to the leaf gasket. Finally, this entire assembly is plumbed to a LI-COR LI-7000 gas analyzer as shown in FIG. 5. The concentration difference between air entering and exiting the inner test chamber is recorded by the gas analyzer. The outer test chamber is plumbed to a controlled flow of 50,000 PPM CO₂ gas at 0.5 SLPM provided from a calibration standard tank.

Six different leaf gasket materials were evaluated:

1. Foamed Neoprene® (with and without adhesive)

2. Foamed Neoprene®/EPDM/SBR blend (with and without adhesive)

3. Foamed Neoprene®Vinyl/Buna-N blend (with and without adhesive)

4. Solid Sorbothane®

5. Foamed Polyethylene

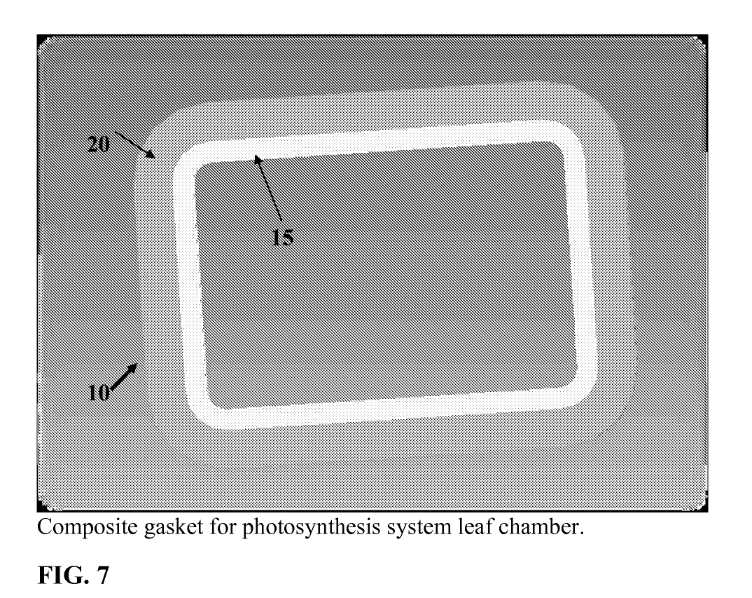

6. Composite geometry of FIG. 7 with FastFlex® solid urethane and polyethylene liner

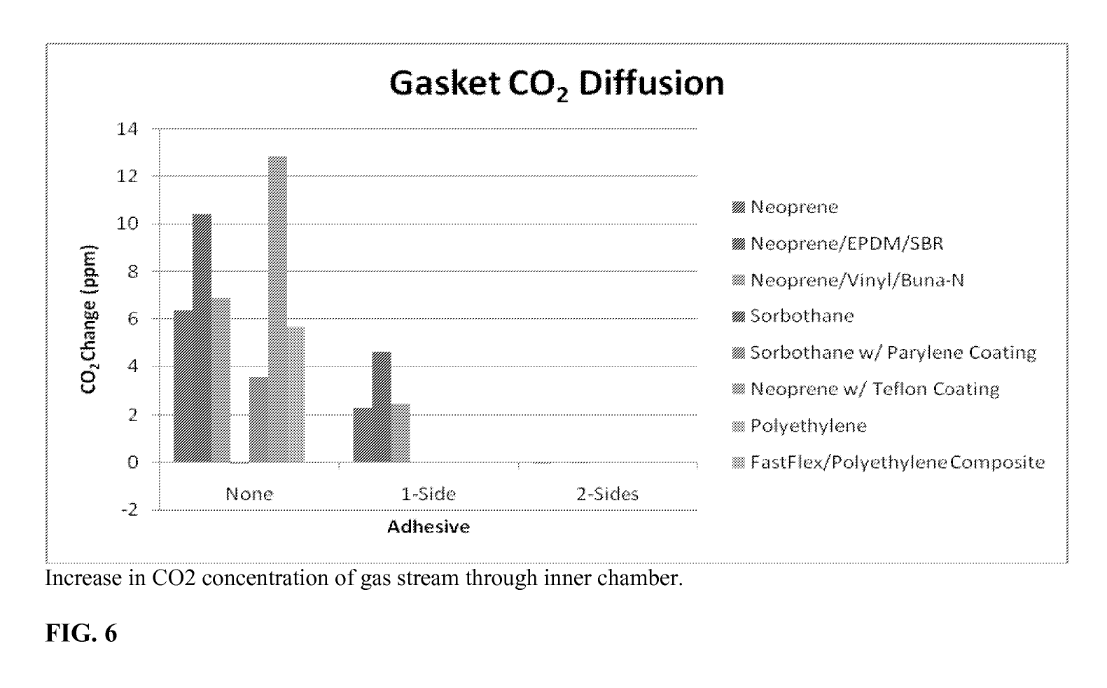

Several different configurations of each gasket material were tested, and not all experimental results will be reviewed. Certain results are highlighted to illustrate the trend and the most significant conclusions. The results for the foamed Neoprene® gasket are shown in FIG. 6. FIG. 6 shows that the concentration difference measured for the interior chamber is just over 6 PPM CO₂. Next, this same Neoprene® material with an acrylic pressure-sensitive-adhesive (PSA) on a single side was tested, and the concentration difference was reduced to just over 2 PPM as shown in FIG. 6, a reduction of approximately 50%. Finally, this same Neoprene® material with PSA on both sides was tested, and the CO₂ difference was reduced to approximately 0 PPM, practically a 100% reduction.

FIG. 6 shows the results of this same Neoprene® gasket with a Teflon® (PTFE) coating applied. The Teflon® coating doubles the CO₂ change from approximately 6 PPM CO₂ without the Teflon® coating, to almost 13 PPM CO₂ with the coating. The Teflon® coating is only 0.003 inches and does not affect the bulk Neoprene® material properties. Thus, the increase must be attributed to the behavior of the Teflon® at the interfaces between the gasket and inner chamber. FIG. 6 shows analogous results for two additional Neoprene® blends: Neoprene®/EPDM/SBR and Neoprene®/vinyl/Buna-N. In each case, adding adhesive to one side of the gasket reduces the CO₂ change by approximately 50%. Adding adhesive to both sides of the gasket reduces the CO₂ change to a negligible value. Thus, virtual elimination of diffusion requires elimination of interfacial diffusion. The PSA in these experiments serves as a mechanism to eliminate interfacial diffusion. Table 1 illustrates results for various materials. Negative values in Table 1 are essentially zero, within the accuracy of the gas analyzer used.

TABLE 1

| Gasket Type | Adhesive | CO₂ Change (ppm) |
|---|---|---|
| Neoprene ® | None | 6.36 |
| Neoprene ® | 1-Side | 2.29 |
| Neoprene ® | 2-Sides | −0.01 |
| Neoprene ®/EPDM/SBR | None | 10.41 |
| Neoprene ®/EPDM/SBR | 1-Side | 4.6 |
| Neoprene ®/EPDM/SBR | 2-Sides | 0 |
| Neoprene ®/Vinyl/Buna-N | None | 6.88 |
| Neoprene ®/Vinyl/Buna-N | 1-Side | 2.41 |
| Neoprene ®/Vinyl/Buna-N | 2-Sides | −0.01 |
| Sorbothane ® | None | −0.02 |
| Sorbothane ® w/Parylene ® Coating | None | 3.57 |
| Neoprene ® w/Teflon ® Coating | None | 12.85 |
| Polyethylene | 1-Side | 5.69 |
| FastFlex/Polyethylene composite | None | −0.03 |

Conditions Inside Chamber: CO₂ 0 ppm; 0.5 L/m Flow
Conditions Outside the Chamber: CO₂ 50,000 ppm; 0.5 L/m Flow

Applying adhesives to leaf chamber gaskets is practically infeasible. However, results in FIG. 6 further demonstrate that a “tacky” surface is similarly effective at eliminating interfacial diffusion. Both Sorbothane® (manufactured by a company of the same name) and FastFlex® are soft urethanes with a naturally tacky surface. Results in FIG. 6 demonstrate that bare Sorbothane® (no adhesive) and a FastFlex®/polyethylene composite perform equivalently to Neoprene® gaskets with adhesive on both sides. The tackiness of soft urethanes is sufficient to eliminate interfacial diffusion. Unlike the acrylic PSA, the adhesion of soft urethanes is weak enough to allow practical use on leaf surfaces. Soft urethanes can also be rinsed with water and will maintain their tacky surface properties.

Unfortunately, most urethanes have a surface affinity for H₂O vapor. Introducing a urethane-only gasket will advantageously eliminate interfacial diffusion, but will also introduce H₂O sorption issues. According to one embodiment, a composite gasket 10 fabricated from two or more materials is provided, for example as illustrated in FIG. 7 for two materials. In one embodiment, the interior material 15 is polyethylene. Polyethylene has virtually no affinity for water vapor, and is therefore an excellent sorption barrier. In one embodiment, the exterior material 20 is FastFlex®, which has all the favorable properties just discussed. The resulting composite gasket advantageously exhibits the interfacial and bulk diffusion free properties of a FastFlex® gasket, while leveraging the low sorption characteristics of a hydrophobic material such as foamed polyethylene. In certain embodiments, the inner material includes a hydrophobic material such as an elastomer. Examples of useful elastomers include solid or foamed polyethylene, Neoprene®, EPDM, SBR, Buna-N and vinyl.

FastFlex™ is a castable urethane available from BJB Enterprises, Inc. It has been found that a +25% ingredient “C” provides the appropriate degree of softness and adhesion. It is not know exactly what “C” is, as it is proprietary to BJB. A pigment, such as white, may be added during the formation process, or the product may be painted or otherwise coated as desired.

In one embodiment, the gasket illustrated in FIG. 7 approximately ⅛″ thick and has interior perimeter dimensions of approximately 2 cm by 3 cm. It should be appreciated that gaskets according to the various embodiments may take on different shapes and sizes to accommodate different instruments, retention techniques and a variety of chamber sizes.

In certain aspects, a composite gasket is fabricated by die-cutting polyethylene to the desired shape, and molding urethane around the perimeter.

In alternate embodiments, the gasket is coated with a hydrophobic material on the interior surface of the gasket to create a sorption barrier that reduces or eliminates sorption of H₂O between the internal measurement volume and the gasket structure. Additionally, the interior surface may have a hydrophobic material affixed or attached thereto to create or enhance a sorption barrier. For example, a urethane (e.g., Sorbothane® or FastFlex®) gasket may be coated with a hydrophobic material, or a hydrophobic material may be affixed to or attached to the inner surface of the urethane gasket. However, a complete coating could interfere with the advantageous surface properties identified. For example, FIG. 6 also shows results for a Parylene® (poly(p-xylylene) polymer) coated Sorbothane® gasket. Parylene® can be applied in very thin layers (0.001″ thick), and is known to be hydrophobic. FIG. 6 shows that a Parylene® coating covers the naturally tacky surface of the Sorbothane® substrate, and increases interfacial diffusion of CO₂. Other useful hydrophobic materials include a wide range of fluoropolymers including Teflon® (PTFE), Aclar®, Neoflon®, along with polyethylene coatings.

Embodiments of the present invention provide certain advantages over the use of greases (e.g. silicone grease), glycerin, petroleum jelly (Vaseline®) and other materials known in the art to prevent leaks at gasket interfaces. The use of grease, glycerin, or petroleum jelly, for example, is not convenient for photosynthesis measurements. Such use requires continual replenishment of the chosen substance and leaves an impervious residue on the leaf surface. The adhesion properties of the gasket embodiment disclosed herein do not suffer these shortcomings.

Also, there are numerous soft silicones which have a tacky surface similar to that of a soft urethanes (e.g., Sorbothane® or FastFlex®). However, silicone rubber is notoriously permeable to a number of common gases. Initial evaluations of soft silicones showed that improvements in surface adhesion were insufficient to overcome diffusion through the bulk material. Thus, these silicone substances were disadvantageous when compared with soft urethane materials.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A gasket for use in a gas exchange system, the gasket comprising:
a structure comprising a first material and having an interior surface defining an interior region, and an exterior surface,
wherein when the structure is positioned between two surfaces in a gas exchange analysis chamber, the interior region defines an internal volume between the two surfaces, and wherein the first material reduces or eliminates interfacial diffusion of gases between the internal volume and the atmosphere external to the gasket when a gas exchange is measured within the analysis chamber.

2. The gasket of claim 1, wherein the first material comprises a solid or foamed elastomer.

3. The gasket of claim 2, wherein the elastomer is a urethane.

4. The gasket of claim 3, wherein the urethane is Sorbothane® or FastFlex® castable urethane.

5. The gasket of claim 1, wherein at least the interior surface of the structure is coated with a hydrophobic material coating, wherein the hydrophobic coating creates a sorption barrier that reduces or eliminates sorption of H₂O between the internal volume and the gasket structure.

6. The gasket of claim 5, wherein the hydrophobic material comprises a layer of poly(p-xylylene) polymer or fluoropolymer.

7. The gasket of claim 1, wherein a hydrophobic material is affixed to at least the interior surface of the structure, wherein the hydrophobic material creates a sorption barrier that reduces or eliminates sorption of H₂O between the internal volume and the gasket structure.

8. The gasket of claim 7, wherein the hydrophobic material comprises a solid or foamed elastomer.

9. The gasket of claim 8, wherein the elastomer is selected from the group consisting of polyethylene, Neoprene®, EPDM, SBR, Buna-N and vinyl.

10. The gasket of claim 1, wherein the first material reduces or eliminates interfacial diffusion of gases selected from the group consisting of CO₂, CO₂ isotopes, O₂, H₂O Methane (CH₄), N₂O, and Isoprene.

11. A composite gasket for use in a gas exchange system, the gasket comprising:
a first gasket portion having an interior surface defining an interior region, and an exterior surface, the first gasket portion comprising a first material;
a second gasket portion affixed to the exterior surface of the first gasket portion, the second gasket portion comprising a second material,
wherein when the composite gasket is positioned between two surfaces, the interior region defines an internal volume between the two surfaces, wherein the first material creates a sorption barrier that reduces or eliminates sorption of H₂O between the internal volume and the composite gasket, and wherein the second material reduces or eliminates interfacial diffusion of gases between the internal volume and the atmosphere external to the gasket.

12. The composite gasket of claim 11, wherein the first material is hydrophobic.

13. The composite gasket of claim 12, wherein the first material comprises a layer of poly(p-xylylene) polymer or fluoropolymer.

14. The composite gasket of claim 12, wherein the hydrophobic material comprises a solid or foamed elastomer.

15. The composite gasket of claim 14, wherein the elastomer is selected from the group consisting of polyethylene, Neoprene®, EPDM, SBR, Buna-N and vinyl.

16. The composite gasket of claim 11, wherein the second material comprises a solid or foamed elastomer.

17. The composite gasket of claim 16, wherein the elastomer is a urethane.

18. The composite gasket of claim 17, wherein the urethane is Sorbothane® or Fastplex® castable urethane.

19. The composite gasket of claim 11, wherein the first material comprises foamed polyethylene and wherein the second material comprises Sorbothane® or FastFlex® castable urethane.

20. A gasket for use in a gas exchange system, the gasket comprising:
a base material defining a structure having an interior surface defining an interior region, and an exterior surface;
a second material affixed to or coating at least the interior surface of the gasket structure;
wherein when the gasket is positioned between two surfaces, the interior region defines an internal volume between the two surfaces, wherein the second material creates a sorption barrier that reduces or eliminates sorption of H₂O between the internal volume and the gasket, and wherein the base material reduces or eliminates interfacial diffusion of gases between the internal volume and the atmosphere external to the gasket.

21. The gasket of claim 20, wherein the base material comprises a solid or foamed elastomer.

22. The gasket of claim 21, wherein the second material comprises polyethylene and wherein the base material comprises a urethane.

23. The gasket of claim 22, wherein the elastomer is Sorbothane® or FastFlex® castable urethane.

24. The gasket of claim 20, wherein the second material comprises a hydrophobic elastomer.

25. The gasket of claim 20, wherein the second material comprises a layer of poly(p-xylylene) polymer or fluoropolymer.
